(19) United States
(12) Patent Application Publication
(10) Pub. No.: US 2026/0017802 A1
(43) Pub. Date: Jan. 15, 2026

(54) IMAGE PROCESSING APPARATUS AND IMAGE PROCESSING METHOD

(71) Applicant: SEIKO EPSON CORPORATION, Tokyo (JP)

(72) Inventor: Toshiaki KAKUTANI, Shiojiri (JP)

(21) Appl. No.: 19/263,550

(22) Filed: Jul. 9, 2025

(30) Foreign Application Priority Data
Jul. 11, 2024 (JP) 2024-111759

(51) Int. Cl. G06T 7/13; G06T 5/20; G06T 5/92

(52) U.S. Cl. CPC G06T 7/13; G06T 5/20; G06T 5/92; G06T 2207/20192

(57) ABSTRACT

An image processing apparatus that converts first image data having a first gradation number into second image data having a second gradation number smaller than the first gradation number by using an error diffusion method. The image processing apparatus includes an edge angle detection processing section that detects an angle of a fine line included in the first image data, and a threshold determination processing section that determines a threshold of the error diffusion method for each pixel included in the first image data based on the angle of the fine line.

The present application is based on, and claims priority from JP Application Serial Number 2024-111759, filed Jul. 11, 2024, the disclosure of which is hereby incorporated by reference herein in its entirety.

### BACKGROUND

### 1. Technical Field

The present disclosure relates to an image processing apparatus and an image processing method.

### 2. Related Art

In the related art, halftone processing is performed on multi-gradation image data read by a scanner or the like or multi-gradation graphic image data calculated by a computer to reduce a gradation number, and an image is formed by using a printer or a display. An error diffusion method is known as a method of halftone processing. However, in a normal error diffusion method, a threshold for determining on/off of dot formation for each pixel is set to a fixed value such as a median value of a range of an input gradation value, and thus there is a case where the quality of an image generated is deteriorated due to a delay or tailing of dot generation. On the other hand, in an error diffusion method described in Japanese Patent No. 3360391, a threshold for a pixel having a gradation value smaller than the median value is set to a value smaller than the median value, and a threshold for a pixel having a gradation value larger than the median value is set to a value larger than the median value. By using an optimized threshold corresponding to the gradation value, the delay and tailing of dot generation can be improved. In particular, when a plurality of pixels having the same gradation value exist with a two-dimensional spread, the delay in dot generation is improved by an appropriate delay amount corresponding to a dot density, and reproducibility of low concentration lines and edges of low concentration areas is significantly improved.

However, there is a problem in that in a fine line having a thickness of approximately 1 to 2 pixels, an area of the line ends before dot generation starts even though a delay is approximately 2 pixels, which leads to disappearance of the fine line. Specifically, in the error diffusion method, binary processing of the multi-gradation input image data is sequentially performed on one pixel unit, there are two processing directions including a main scanning direction in which processing of one raster is performed on a pixel unit and a sub-scanning direction in which the processing is moved to the next raster processing, and a quantization error generated by the binarization of one pixel is distributed to a plurality of unprocessed pixels in the vicinity thereof with a weight value defined by an error diffusion matrix and diffused, and thus directionality of the error distribution caused by the processing directions and the error diffusion matrix occurs. Due to the directionality of the error distribution, in general, when the main scanning direction is right and the sub-scanning direction is down, the reproducibility of the fine line in a lower-right direction (135°) is good, but the fine line in a lower-left direction (45°) in a vertical direction is not easily reproduced and may disappear. As a measure for this problem, there is a method disclosed in Japanese Patent No. 3360391 in which a threshold is set to be equal to or smaller than an optimized threshold in a low concentration area for setting to an overcorrection state, thereby accelerating dot generation. As a result, there is an effect of preventing the disappearance of a line by accelerating the dot generation at an edge portion. However, when correction is performed excessively, there is a concern that an accumulation of errors occurs and side effects such as tailing occur.

### SUMMARY

According to an aspect of the present disclosure, there is provided an image processing apparatus configured to convert first image data having a first gradation number into second image data having a second gradation number smaller than the first gradation number by using an error diffusion method, the apparatus including: an edge angle detection processing section configured to detect an angle of a fine line included in the first image data; and a threshold determination processing section configured to determine a threshold of the error diffusion method for each pixel included in the first image data based on the angle of the fine line.

According to another aspect of the present disclosure, there is provided an image processing apparatus configured to convert first image data having a first gradation number into second image data having a second gradation number smaller than the first gradation number by using an error diffusion method, the apparatus including: an edge angle detection processing section configured to detect an angle of a fine line included in the first image data; and an edge enhancement processing section configured to increase a gradation value of the fine line in correspondence with the angle of the fine line, in which the image processing apparatus converts the first image data in which the gradation value of the fine line is increased into the second image data by using the error diffusion method.

According to still another aspect of the present disclosure, there is provided an image processing method of converting first image data having a first gradation number into second image data having a second gradation number smaller than the first gradation number by using an error diffusion method, the method including: detecting an angle of a fine line included in the first image data; and determining a threshold of the error diffusion method for the fine line based on the angle of the fine line.

According to still another aspect of the present disclosure, there is provided an image processing method of converting first image data having a first gradation number into second image data having a second gradation number smaller than the first gradation number by using an error diffusion method, the method including: detecting an angle of a fine line included in the first image data; increasing a gradation value of the fine line in correspondence with the angle of the fine line; and converting the first image data in which the gradation value of the fine line is increased into the second image data by using the error diffusion method.

### BRIEF DESCRIPTION OF THE DRAWINGS

FIG. 1 is a schematic configuration diagram of an image processing apparatus according to a first embodiment.

FIG. 2 is a flowchart illustrating a procedure of an image processing method.

FIG. 3 is a flowchart illustrating a procedure of halftone processing of a comparative example.

FIG. 4 is a view illustrating an arrangement example of pixels.

FIG. 5 is a view illustrating an example of a correspondence relationship between a gradation value of a pixel and an optimized threshold.

FIG. 6 is an explanatory view illustrating error diffusion processing.

FIG. 7 is a view illustrating a fine line having a width of one pixel.

FIG. 8 is a view illustrating reproducibility of a fine line having a width of one pixel.

FIG. 9 is a flowchart illustrating a procedure of halftone processing of the first embodiment.

FIG. 10 is a view illustrating an example of an edge detection filter.

FIG. 11 is a view illustrating a threshold at which a fine line is reproduced with substantially the same dot density as an input gradation value for a combination of the input gradation value of the fine line and an angle.

FIG. 12 is a view illustrating an example of an edge detection filter.

FIG. 13 is a view illustrating an example of the edge detection filter.

FIG. 14 is a view illustrating an example of the edge detection filter.

FIG. 15 is a view illustrating an example of the edge detection filter.

FIG. 16 is a schematic configuration diagram of an image processing apparatus according to a second embodiment.

FIG. 17 is a flowchart illustrating a procedure of halftone processing of the second embodiment.

### DESCRIPTION OF EMBODIMENTS

Hereinafter, appropriate embodiments of the present disclosure will be described with reference to the drawings. The drawings to be used are for convenience of description. In addition, the embodiments to be described below do not inappropriately limit the contents of the present disclosure described in the claims. Moreover, not all of configurations to be described below are necessarily essential components of the present disclosure.

### 1. First Embodiment

### 1-1. Configuration of Image Processing Apparatus

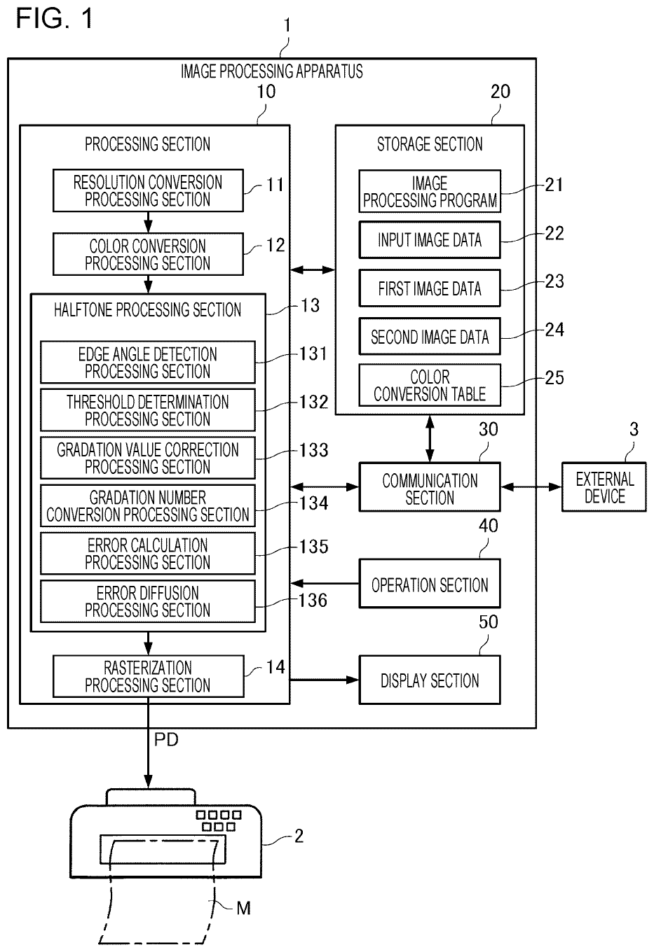

FIG. 1 is a block diagram illustrating a configuration of an image processing apparatus 1 according to a first embodiment. As shown in FIG. 1, the image processing apparatus 1 processes input image data to generate print data PD, and outputs the print data PD to be transferred to the printer 2. The image processing apparatus 1 is, for example, a personal computer, and can be coupled to an external device 3 such as a digital camera, a memory card, a USB flash drive, or the like via various ports (not illustrated), and can be coupled to an external device 3 such as various servers or information terminals via a network. The image processing apparatus 1 acquires the input image data from, for example, the external device 3. The printer 2 forms an output image corresponding to the input image data on the medium M based on the print data PD. The printer 2 is, for example, an ink jet printer that can form a full-color image.

As shown in FIG. 1, the image processing apparatus 1 includes a processing section 10, a storage section 20, a communication section 30, an operation section 40, and a display section 50. The image processing apparatus 1 may be configured by omitting or changing a part of the constituent elements in FIG. 1, or adding other constituent elements.

The processing section 10 acquires input image data and performs image processing. Specifically, the processing section 10 executes an image processing program 21 stored in the storage section 20 and performs image processing on input image data 22 stored in the storage section 20. The input image data 22 is, for example, RGB image data. In addition, the processing section 10 performs various kinds of processing corresponding to an operation signal from the operation section 40, processing of displaying various images on the display section 50, processing of controlling the communication section 30 to perform data communication with the external device 3, and the like. The processing section 10 is realized by, for example, a central processing unit (CPU) or a digital signal processor (DSP).

The processing section 10 functions as a resolution conversion processing section 11, a color conversion processing section 12, a halftone processing section 13, and a rasterization processing section 14 by executing the image processing program 21. That is, the image processing apparatus 1 includes the resolution conversion processing section 11, the color conversion processing section 12, the halftone processing section 13, and the rasterization processing section 14.

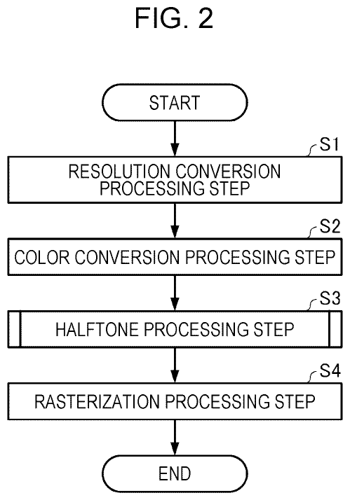

FIG. 2 is a flowchart illustrating a procedure of an image processing method using the image processing apparatus 1. In FIG. 2, first, in a resolution conversion processing step S1, the processing section 10 of the image processing apparatus 1 functions as the resolution conversion processing section 11. The resolution conversion processing section 11 performs processing of converting resolution (that is, the number of pixels per unit length) of the input image data 22, which is RGB image data, into resolution that can be printed by the printer 2.

Next, in a color conversion processing step S2, the processing section 10 functions as the color conversion processing section 12. The color conversion processing section 12 converts the resolution-converted input image data 22 into multi-gradation data of a plurality of ink colors that can be used by the printer 2 with reference to a color conversion table 25 stored in the storage section 20. The multi-gradation data is stored in the storage section 20 as first image data 23 having a first gradation number. The first gradation number is, for example, 256, and each pixel of the first image data 23 has a gradation value of 0 to 255.

Next, in the halftone processing step S3, the processing section 10 functions as the halftone processing section 13. The halftone processing section 13 converts the first image data 23 having the first gradation number into second image data 24 having a second gradation number smaller than the first gradation number. In the present embodiment, the halftone processing section 13 executes halftone processing of generating the second image data 24 that determines whether or not to form a dot in each of a plurality of pixels constituting an output image based on the gradation value of the first image data 23 by an error diffusion method. The second image data 24 is stored in the storage section 20. The halftone processing is binary processing of forming or not forming a dot when a size of the dot that can be formed by the printer 2 is one type, and the second gradation number is 2. In addition, the halftone processing is ternary processing of none, small, and large when two types of dots of small and large can be formed, and the second gradation number is 3. In addition, the halftone processing is quaternary processing of none, small, medium, and large when three types of ink dots of small, medium, and large can be formed, and the second gradation number is 4. In the following description, it is assumed that the printer 2 can form one type of dot, and the image processing apparatus 1 performs binary processing as the halftone processing.

As shown in FIG. 1, the halftone processing section 13 includes an edge angle detection processing section 131, a threshold determination processing section 132, a gradation value correction processing section 133, a gradation number conversion processing section 134, an error calculation processing section 135, and an error diffusion processing section 136, and the halftone processing is executed by each section performing each processing. Details of the halftone processing will be described later.

Finally, in the rasterization processing step S4, the processing section 10 functions as the rasterization processing section 14. The rasterization processing section 14 rearranges the halftone-processed second image data 24 in a data order to be transferred to the printer 2, and outputs the rearranged data to the printer 2 as final print data PD. The print data PD includes raster data indicating a recording state of each dot at the time of main scanning and data indicating a sub-scanning feed amount.

As shown in FIG. 1, the storage section 20 includes a read only memory (ROM) and a random access memory (RAM) (not illustrated). The ROM stores various programs such as the image processing program 21 and predetermined data such as the color conversion table 25, and the RAM stores the input image data 22 acquired via the communication section 30. The RAM is also used as a work area of the processing section 10, and stores a program or data read from the ROM, data input from the operation section 40, the first image data 23, the second image data 24, and the like generated by the processing section 10.

The communication section 30 performs various controls for enabling data communication between the processing section 10 and the external device 3. Further, the communication section 30 acquires the input image data 22 from the external device 3 and stores the input image data 22 in the storage section 20.

The operation section 40 is an input device configured with an operation key, a button switch, or the like, and outputs an operation signal corresponding to an operation by a user to the processing section 10.

The display section 50 is a display device configured by a liquid crystal display (LCD) or the like, and displays various images based on a display signal output from the processing section 10. A touch panel that functions as the operation section 40 may be provided in the display section 50. For example, the display section 50 displays information related to various states of the image processing apparatus 1.

At least a part of the resolution conversion processing section 11, the color conversion processing section 12, the halftone processing section 13, and the rasterization processing section 14 may be realized by dedicated hardware. In addition, a part of the information stored in the storage section 20, or a part of the resolution conversion processing section 11, the color conversion processing section 12, the halftone processing section 13, and the rasterization processing section 14 may be provided in the printer 2. For example, the printer 2 may receive image data that is not subjected to the halftone processing from the image processing apparatus 1, perform the halftone processing, and then perform printing processing.

Hereinafter, the halftone processing of generating the second image data 24 which is dot data will be described. Hereinafter, description will be given on the assumption that the second gradation number of the second image data 24 is 2, that is, the second image data 24 is image data indicating on/off of dot formation for each pixel. The halftone processing is performed by an error diffusion method. First, the halftone processing using the error diffusion method described in Japanese Patent No. 3360391 will be described as a comparative example, and the content and problems thereof will be described, and then the halftone processing of the present embodiment will be described.

### 1-2. Halftone Processing of Comparative Example

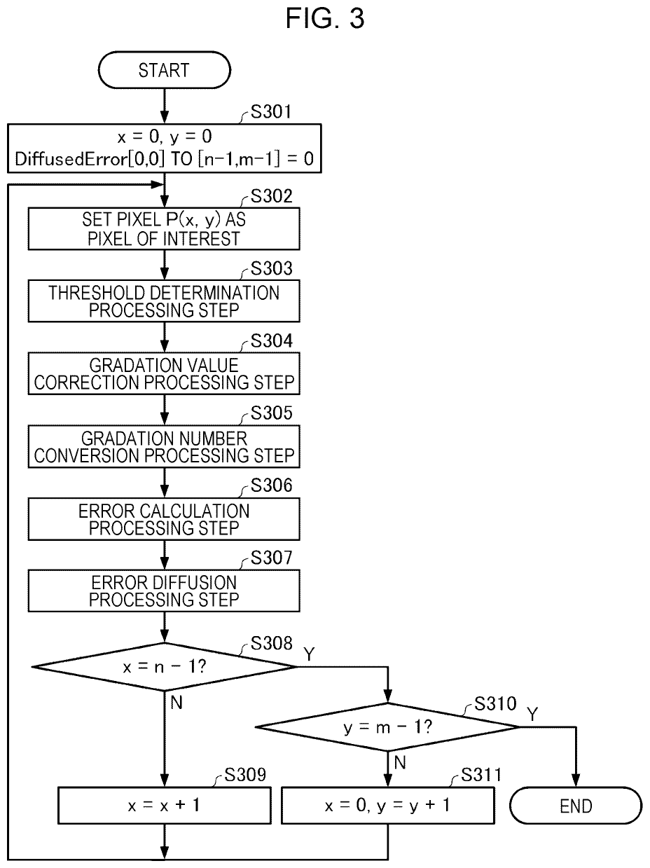

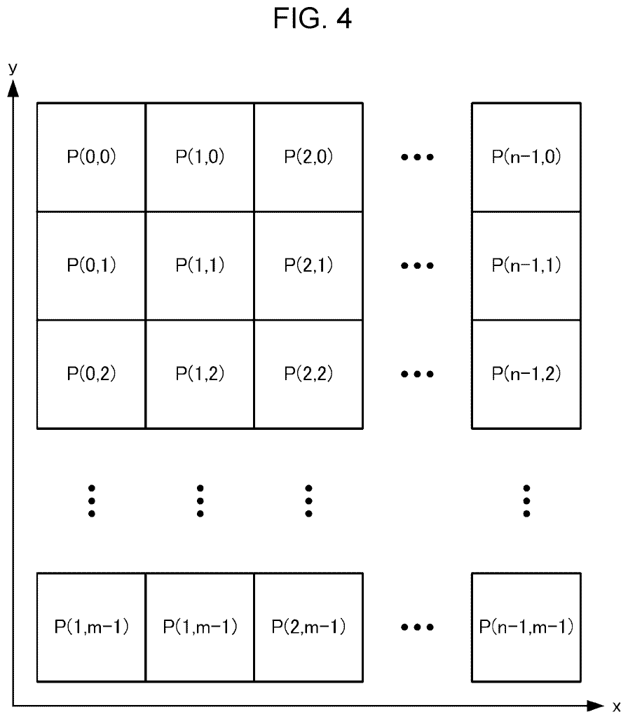

FIG. 3 is a flowchart illustrating a procedure of the halftone processing of the comparative example. The halftone processing of the comparative example is processing of converting a gradation value of each pixel P(x, y) having any gradation value of 0 to 255 into a gradation value of 0 or 255, and is performed by a halftone processing section 13A (not illustrated). As shown in FIG. 4, x is a coordinate in a lateral direction, y is a coordinate in a downward direction, and a pixel in an upper-left corner is P(0, 0) and a pixel in a lower-right corner is P(n−1, m−1).

As shown in FIG. 3, the halftone processing section 13A initializes the coordinates x and y to 0 in step S301. In step S302, the halftone processing section 13A sets the pixel P(x, y) included in the first image data 23 to a pixel of interest (a processing target pixel), and performs processing from step S303 on the pixel P(x, y).

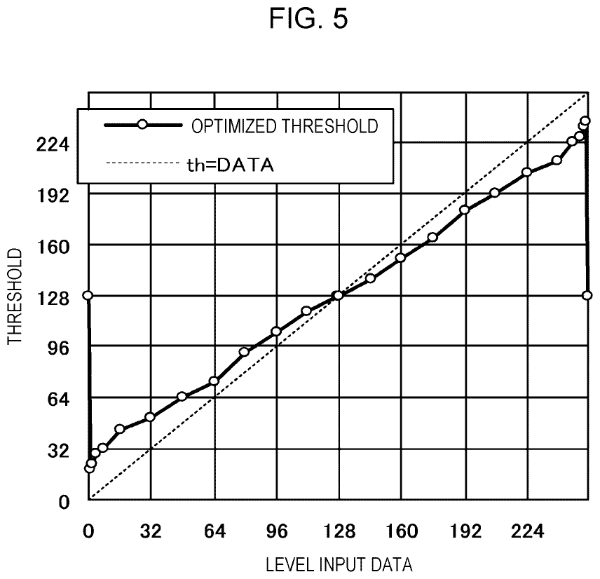

First, in threshold determination processing step S303, the halftone processing section 13A determines the threshold EdThreshold(Data[x, y]) for the pixel of interest P(x, y) based on the gradation value Data[x, y] of the pixel of interest P(x, y). For example, a correspondence relationship between the gradation value and the optimized threshold as shown in FIG. 5 is obtained by investigating the optimized threshold, at which an average value of the quantization error when the gradation value of all pixels of the first image data 23 is set to the same value in advance and the gradation value of all pixels corrected by the same processing as the gradation value correction processing step S304 described later is binarized is zero, by changing the gradation value from 0 to 255. The storage section 20 stores table information on the correspondence relationship, and the halftone processing section 13A refers to the table information in threshold determination processing step S303 to determine the optimized threshold corresponding to the gradation value [Data[x, y] of the pixel of interest P(x, y) as the threshold EdThreshold(Data[x, y]).

Next, in gradation value correction processing step S304, the halftone processing section 13A corrects the gradation value of the pixel of interest P(x, y) by adding an accumulated error DiffusedError[x, y] obtained by accumulating an error diffused from a plurality of pixels P converted to the gradation value of the second gradation number around the pixel of interest P(x, y) in error diffusion processing step S307 described later to the gradation value Data[x, y] of the pixel of interest P(x, y). A corrected gradation value CorrectData[x, y] is calculated by an equation of CorrectData[x, y]=Data[x, y]+DiffusedError[x, y].

Next, in gradation number conversion processing step S305, the halftone processing section 13A compares the gradation value CorrectData[x, y] corrected in step S304 with the threshold EdThreshold(Data[x, y]) determined in step S303 with respect to the pixel of interest P(x, y), and converts the gradation value into the gradation value Data2[x, y] of the second gradation number based on the comparison result. Specifically, the halftone processing section 13A sets Data2[x, y]=255 (dot: on) when CorrectData[x, y]>EdThreshold(Data[x, y]) is established, and sets Data2[x, y]=0 (dot: off) when CorrectData[x, y]≤EdThreshold(Data[x, y]) is established.

Next, in error calculation processing step S306, the halftone processing section 13A calculates an error Error[x, y] between the gradation value CorrectData[x, y] corrected in step S304 and gradation value Data2[x, y] of the second gradation number converted in step S305 for the pixel of interest P(x, y). That is, Error[x, y]=CorrectData[x, y]-Data2[x, y].

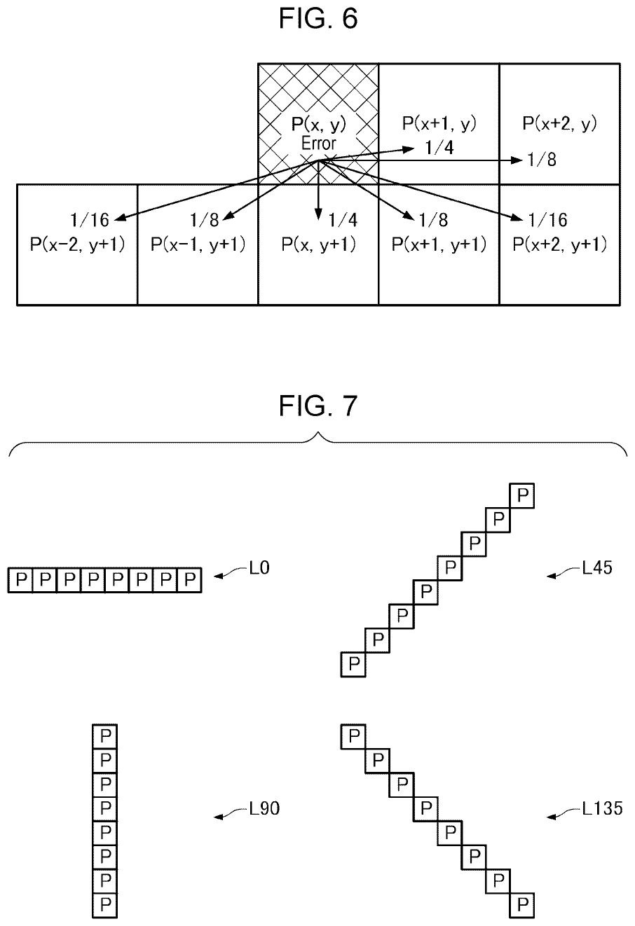

Next, in error diffusion processing step S307, the halftone processing section 13A diffuses the error Error[x, y] calculated in step S306 to the plurality of pixels P around the pixel of interest P(x, y) to update the accumulated error DiffusedError. As an example, as shown in FIG. 6, the halftone processing section 13A diffuses the Error[x, y] to ¼, ⅛, 1/16, ⅛, ¼, ⅛, and 1/16 times for each of seven pixels P including a pixel P(x+1, y), a pixel P(x+2, y), a pixel P(x−2, y+1), a pixel P(x−1, y+1), a pixel P(x, y+1), a pixel P(x+1, y+1), and a pixel P(x+2, y+1) around the pixel of interest P(x, y), and updates each accumulated error DiffusedError according to the following Equations (1) to (7).

$$DiffusedError [ x + 1 , y ] = DiffusedError [ x + 1 , y ] + Error [ x , y ] / 4 \qquad ( 1 )$$

$$DiffusedError [ x + 2 , y ] = DiffusedError [ x + 2 , y ] + Error [ x , y ] / 8 \qquad ( 2 )$$

$$DiffusedError [ x - 2 , y + 1 ] = DiffusedError [ x - 2 , y + 1 ] + Error [ x , y ] / 16 \qquad ( 3 )$$

$$DiffusedError [ x - 1 , y + 1 ] = DiffusedError [ x - 1 , y + 1 ] + Error [ x , y ] / 8 \qquad ( 4 )$$

$$DiffusedError [ x , y + 1 ] = DiffusedError [ x , y + 1 ] + Error [ x , y ] / 4 \qquad ( 5 )$$

$$DiffusedError [ x + 1 , y + 1 ] = DiffusedError [ x + 1 , y + 1 ] + Error [ x , y ] / 8 \qquad ( 6 )$$

$$DiffusedError [ x + 2 , y + 1 ] = DiffusedError [ x + 2 , y + 1 ] + Error [ x , y ] / 16 \qquad ( 7 )$$

Next, when x≠n−1 in step S308, the halftone processing section 13A sets x to x+1 (that is, x=x+1) in step S309, and performs processing from step S302 again. That is, the halftone processing section 13A performs the processing from step S302 on a pixel P(x+1, y) that is a right neighboring pixel of the pixel P(x, y) when x=n−1 in step S308.

Further, the halftone processing section 13A performs the processing from step S302 again when x=n−1 in step S308, and when y≠m−1 in step S310 by setting x to 0 (that is, x=0) and by setting y to y+1 (that is, y=y+1) in step S311. That is, when x=n−1 in step S308, the pixel P(x, y) is located at the right end, and thus the halftone processing section 13A performs the processing from step S302 with respect to the pixel P(0, y+1) at a left end of a next raster.

Further, the halftone processing section 13A ends the halftone processing when y=m−1 in step S310. That is, when y=m−1 in step S310, since the pixel P(x, y) is located at the lower-right corner, the gradation number conversion processing for all the pixels P shown in FIG. 4 is already ended, and thus the halftone processing section 13A ends the halftone processing.

In the normal error diffusion method, the threshold compared with the gradation value CorrectData[x, y] in step S305 is set to a value around 127.5, which is the median value. On the other hand, in the halftone processing of the comparative example, the threshold EdThreshold(Data[x, y]) is set to a value smaller than 127.5 on a low gradation side where the gradation value Data[x, y] of the pixel of interest P(x, y) is smaller than 128, and is set to a value larger than 127.5 on a high gradation side where the gradation value Data[x, y] is 128 or larger. As a result, the delay and tailing of the dot generation can be improved. In particular, by setting an optimized threshold for each gradation value Data[x, y] as shown in FIG. 5, when a plurality of pixels P having the same gradation value have a two-dimensional spread, the delay in dot generation is improved to an appropriate delay amount corresponding to dot density, and the reproducibility of low concentration lines and edges of the low concentration area is significantly improved. For example, when the gradation number is 256 (the gradation value is in a range of 0 to 255) and the gradation value Data[x, y] is 16, a formed dot density is approximately one dot in a range of 4×4 pixels, and a delay in dot generation of approximately two pixels can be said to be an appropriate delay amount. In the following description, for example, a gradation value of 16 or the like when the gradation number is 256 (the gradation value is in a range of 0 to 255) may be described as a gradation value of 16/255 or the like.

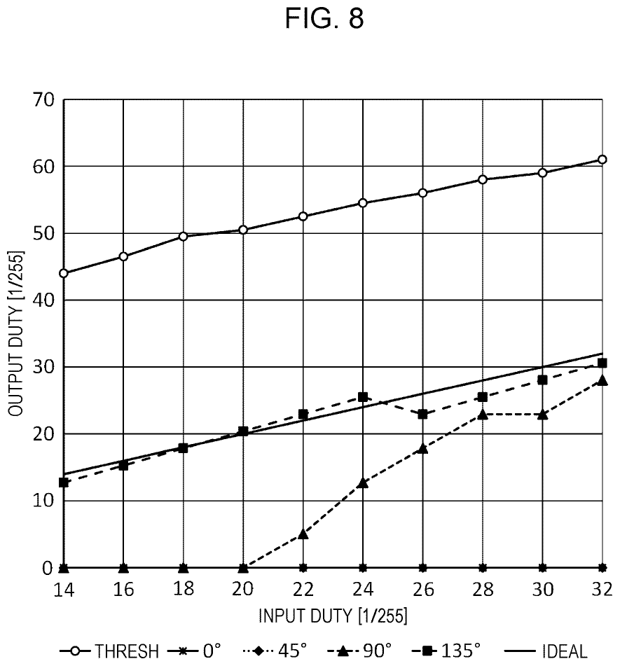

However, there is a problem in that in a fine line having a thickness of approximately 1 to 2 pixels, an area of the line ends before dot generation starts even though a delay is approximately 2 pixels, which leads to disappearance of the fine line. Specifically, by applying the error diffusion method described in Japanese Patent No. 3360391, the reproducibility of fine lines having a width of one pixel at four types of angles as shown in FIG. 7 (dot ON rate on the fine lines) was investigated for a range where the gradation value of the fine lines is 32/255 or less, and a graph shown in FIG. 8 was obtained. In FIG. 7, L1 is a fine line in a horizontal direction (0°), and each of L2, L3, and L4 is a fine line having an inclination of each of 45°, 90°, and 135° counterclockwise with respect to the horizontal direction of 0°. In a reproducibility investigation of a low concentration fine line according to an angle, as indicated by a white circle in FIG. 8, the optimized threshold shown in FIG. 5 is used in correspondence with a gradation value of the fine line, and a suitable amount of random noise is added to the gradation value Data[x, y] of each pixel P(x, y) for the purpose of preventing occurrence of a regular dot pattern.

As shown in FIG. 8, among the four types of fine lines, only the fine line of 135° is reproduced at a dot density close to an input gradation value, and the fine line of 0° and the fine line of 45° disappear without generating dots when the input gradation value is 32/255 or less, and the fine line of 90° also disappears without generating dots when the input gradation value is 20/255 or less. In any case, a remarkable anisotropy occurs in an area of approximately 10% or less of the dot density, and a difference is reduced even in a fine line having a width of 2 pixels, but the same tendency remains.

As a measure for this problem, there is a method disclosed in Japanese Patent No. 3360391 in which a threshold is set to be equal to or smaller than an optimized threshold in a low concentration area for setting to an overcorrection state, thereby accelerating dot generation. As a result, there is an effect of preventing the disappearance of a line by accelerating the dot generation at an edge portion. However, when correction is performed excessively, there is a concern that an accumulation of errors occurs and side effects such as tailing occur. Therefore, in the halftone processing of the present embodiment, the optimized threshold is determined by considering not only the gradation value of the pixel P but also the edge angle.

### 1-3. Halftone Processing of Present Embodiment

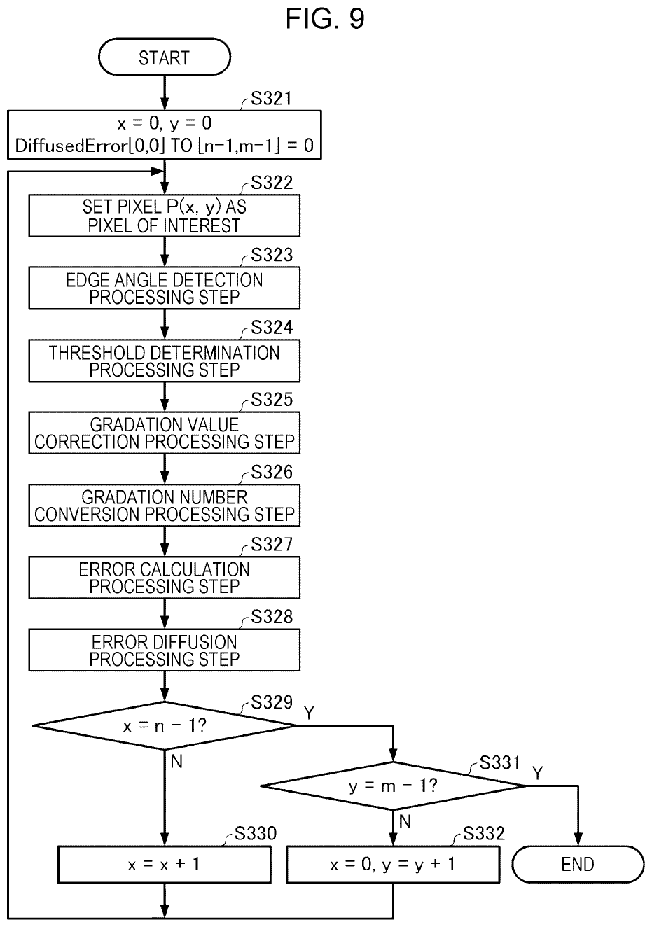

FIG. 9 is a flowchart illustrating a procedure of the halftone processing of the present embodiment. The halftone processing of the present embodiment is processing of converting the gradation value of each pixel P(x, y) having any gradation value of 0 to 255 into a gradation value of 0 or 255, and is performed by the halftone processing section 13 shown in FIG. 1.

As shown in FIG. 9, the halftone processing section 13 initializes coordinates x and y to 0 in step S321. In step S322, the halftone processing section 13 sets the pixel P(x, y) included in the first image data 23 as a pixel of interest (a processing target pixel), and performs the processing from step S323 on the pixel P(x, y).

First, the halftone processing section 13 functions as the edge angle detection processing section 131 shown in FIG. 1 in edge angle detection processing step S323, and the edge angle detection processing section 131 detects an angle of a fine line included in the first image data 23. The fine line to be detected has, for example, a width of one pixel or two pixels. The edge angle detection processing section 131 may apply a plurality of filters for detecting each of a plurality of angles in a range of 0° to 180° to the fine line, and detect the angle of the fine line based on application results of the plurality of filters. Specifically, in edge angle detection processing step S323, the edge angle detection processing section 131 detects the edge angle angle_type of the pixel of interest P(x, y) as follows.

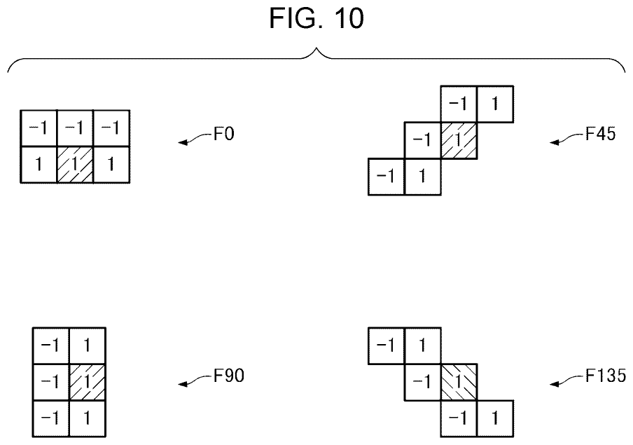

First, the edge angle detection processing section 131 classifies a direction of the fine line or the edge into four directions centered around 0°, 45°, 90°, and 135° counterclockwise with an x-direction (a main scanning direction) set to 0°, and uses the edge detection filters for the four types of angles obtained through division in a unit of 45° as shown in FIG. 10 to obtain an edge intensity in each direction for the pixel of interest P(x, y). In FIG. 10, F0 is an example of a filter that detects an edge of 0°, F45 is an example of a filter that detects an edge of 45°, F90 is an example of a filter that detects an edge of 90°, and F135 is an example of a filter that detects an edge of 135°. In each filter, a position with a hatching corresponds to the position of the pixel of interest P(x, y).

The edge angle detection processing section 131 calculates an edge intensity in four directions of the pixel of interest P(x, y) by obtaining the sum by multiplying a gradation value of the pixel of interest P(x, y) and gradation values of a plurality of pixels P in the vicinity of the pixel of interest P(x, y) by a coefficient of each position corresponding to the filter. That is, the edge angle detection processing section 131 calculates an edge intensity edge_level_00 in a direction of 0°, an edge intensity edge_level_45 in a direction of 45°, an edge intensity edge_level_90 in a direction of 90°, and an edge intensity edge_level_135 in a direction of 135° by the following Equations (8) to (11).

$$edge\_level \_ 00 = Data [ x - 1 , y ] + Data [ x , y ] + Data [ x + 1 , y ] - ( Data [ x - 1 , y - 1 ] + Data [ x , y - 1 ] + Data [ x + 1 , y - 1 ] ) \qquad ( 8 )$$

$$edge\_level \_ 45 = Data [ x - 1 , y + 1 ] + Data [ x , y ] + Data [ x + 1 , y - 1 ] - ( Data [ x - 2 , y + 1 ] + Data [ x - 1 , y ] + Data [ x , y - 1 ] ) \qquad ( 9 )$$

$$edge\_level \_ 90 = Data [ x , y - 1 ] + Data [ x , y ] + Data [ x , y + 1 ] - ( Data [ x - 1 , y - 1 ] + Data [ x - 1 , y ] + Data [ x - 1 , y + 1 ] ) \qquad ( 10 )$$

$$edge\_level \_ 135 = Data [ x - 1 , y - 1 ] + Data [ x , y ] + Data [ x + 1 , y + 1 ] - ( Data [ x - 2 , y - 1 ] + Data [ x - 1 , y ] + Data [ x , y + 1 ] ) \qquad ( 11 )$$

The edge angle detection processing section 131 sets a maximum value among the edge intensities edge_level_00, edge_level_45, edge_level_90, and edge_level_135 in the four directions of the pixel of interest P(x, y) as the edge intensity edge_level of the pixel of interest P(x, y) by the following Equation (12).

$$edge\_level = max ( edge\_level \_ 00 , edge\_level \_ 45 , edge\_level \_ 90 , edge\_level \_ 135 ) \qquad ( 12 )$$

Further, the edge angle detection processing section 131 sets the maximum angle among the edge intensities edge_level_00, edge_level_45, edge_level_90, and edge_level_135 of the pixel of interest P(x, y) in the four directions as an edge angle angle_type of the pixel of interest P(x, y). That is, when edge_level=edge_level_00, angle_type=0 (angle of 0°), when edge_level=edge_level_45, angle_type=1 (angle of 45°), when edge_level=edge_level_90, angle_type=2 (angle of 90°), and when edge_level=edge_level_135, angle_type=3 (angle of 135°). For example, when the pixel of interest P(x, y) is a pixel on a fine line at an angle of 45°, the edge intensity edge_level_45 is maximized, and the edge angle angle_type=1 (angle of 45°) is obtained.

When the edge intensity in the two directions is the maximum among the four directions, an intermediate angle between the two angles corresponding to the two directions may be used as the edge angle angle_type. For example, when the two edge intensities edge_level_45 and edge_level_90 are both maximum, the edge angle angle_type may be set to 1.5 (angle of 67.5° (=(45°+90°)/2)), and detected angles are not limited to four types of 0°, 45°, 90°, and 135°, and may be two types, three types, or five or more types. Alternatively, only one type of angle at which the fine line is likely to disappear may be detected.

Next, in threshold determination processing step S324, the halftone processing section 13 functions as the threshold determination processing section 132 shown in FIG. 1, and the threshold determination processing section 132 determines the threshold of the error diffusion method for each pixel included in the first image data 23 based on the angle of the fine line detected in step S323. Specifically, in threshold determination processing step S324, the threshold determination processing section 132 determines a threshold EdThreshold(angle_type) for the pixel of interest P(x, y) based on the edge angle angle_type of the pixel of interest P(x, y) detected in step S323. In particular, based on the result of the preliminary investigation described below, in threshold determination processing step S324, it is preferable that the threshold determination processing section 132 determines the threshold of the error diffusion method for each pixel based on the angle of the fine line detected in step S323 and the gradation value of each pixel included in the first image data 23. Specifically, it is preferable that the threshold determination processing section 132 determines the threshold EdThreshold(Data[x, y], angle_type) for the pixel of interest P(x, y) based on the gradation value Data[x, y] of the pixel of interest P(x, y) and the edge angle angle_type.

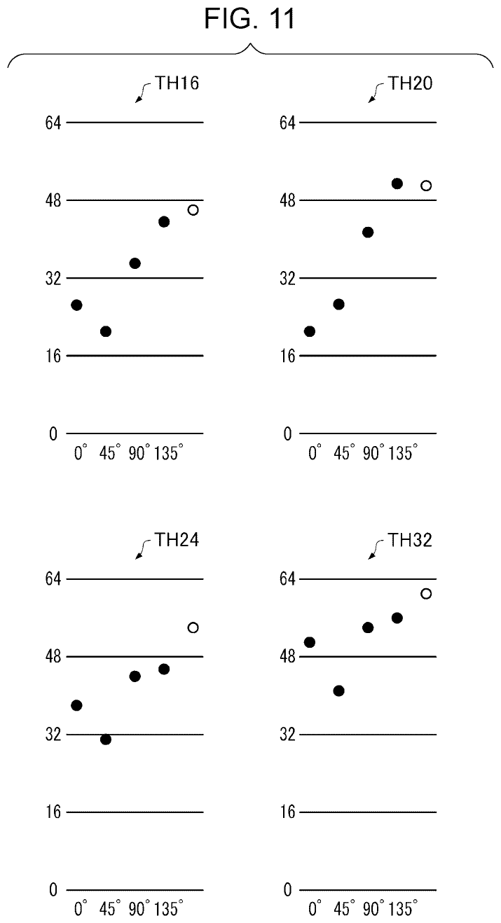

Japanese Patent No. 3360391 discloses that edge enhancement that accelerates dot generation at a low dot density, that is, a low concentration can be performed by reducing the threshold. Therefore, as a result of investigating the threshold necessary for performing the edge enhancement until four types of input gradation values of 16/255, 20/255, 24/255, and 32/255 and the dot ON rate on the fine line substantially match with respect to the fine line in the four directions of 0°, 45°, 90°, and 135°, a graph shown in FIG. 11 is obtained. That is, the graph of FIG. 11 shows the threshold for reproducing the fine line of any angle with substantially the same dot density as the input gradation value in the combination of the four types of input gradation values of 16/255, 20/255, 24/255, and 32/255 and the edge angles in the four directions of 0°, 45°, 90°, and 135°. In FIG. 11, as TH16, a threshold for each edge angle when the input gradation value is 16/255 is indicated by a black circle, as TH20, a threshold for each edge angle when the input gradation value is 20/255 is indicated by a black circle, as TH24, a threshold for each edge angle when the input gradation value is 24/255 is indicated by a black circle, and as TH32, a threshold for each edge angle when the input gradation value is 32/255 is indicated by a black circle. In TH16, TH20, TH24, and TH32, the optimized threshold shown in FIG. 8 is indicated by a white circle.

From the graph shown in FIG. 11, for example, when the input gradation value is 16/255, the thresholds to be set are 45°, 0°, 90°, and 135° in an ascending order. In FIG. 11, the difference between the optimized threshold indicated by a white circle and the threshold to be set is an edge enhancement amount by a threshold operation, and the edge enhancement by the threshold operation is increased in this order. In addition, in FIG. 11, when compared in a unit of 90°, it can be seen that 0° and 90° require stronger edge enhancement at 0°, and 45° and 135° require stronger edge enhancement at 45°.

Therefore, as shown in FIG. 11, table information on a correspondence relationship between the gradation value and the edge angle is stored in the storage section 20, and the threshold determination processing section 132 can determine the threshold corresponding to the gradation value Data[x, y] and the edge angle angle_type of the pixel of interest P(x, y) as the threshold EdThreshold(Data[x, y], angle_type) with reference to the table information in threshold determination processing step S324.

It is noted that in threshold determination processing step S324, the gradation value of the fine line for which the threshold determination processing section 132 determines the threshold in correspondence with the edge angle angle_type may be equal to or less than a predetermined value. For example, when the fine line having a gradation value of 32 or less is likely to disappear, the predetermined value may be set to 32. That is, when the gradation value Data[x, y] of the pixel of interest P(x, y) is equal to or less than the predetermined value, the threshold determination processing section 132 may determine the threshold EdThreshold(Data[x, y], angle_type) based on the gradation value Data[x, y] and the edge angle angle_type of the pixel of interest P(x, y), and when the gradation value Data[x, y] of the pixel of interest P(x, y) is greater than the predetermined value, the threshold determination processing section 132 may determine the threshold EdThreshold(Data[x, y]) based on the gradation value Data[x, y] of the pixel of interest P(x, y) similarly to the halftone processing of the comparative example.

In addition, the threshold determination processing section 132 may obtain the threshold for the edge angle angle_type not defined by the table information by linear interpolation calculation or the like from thresholds for a plurality of defined edge angles. For example, when the gradation value Data[x, y] of the pixel of interest P(x, y) is 18/255, the threshold determination processing section 132 can determine an average value of the threshold when the input gradation value is 16/255 and the threshold when the input gradation value is 20/255 as the threshold EdThreshold(Data[x, y], angle_type).

Next, in gradation value correction processing step S325, the halftone processing section 13 functions as the gradation value correction processing section 133 shown in FIG. 1, and the gradation value correction processing section 133 corrects the gradation value of the pixel of interest P(x, y) by adding an accumulated error DiffusedError[x, y] obtained by accumulating the error diffused from the plurality of pixels P converted to the gradation value of the second gradation number around the pixel of interest P(x, y) in error diffusion processing step S328 described later to the gradation value Data[x, y] of the pixel of interest P(x, y). A corrected gradation value CorrectData[x, y] is calculated by an equation of CorrectData[x, y]=Data[x, y]+DiffusedError[x, y].

Next, in gradation number conversion processing step S326, the halftone processing section 13 functions as the gradation number conversion processing section 134 shown in FIG. 1, and the gradation number conversion processing section 134 compares the gradation value CorrectData[x, y] corrected in step S325 with the threshold EdThreshold(Data[x, y], angle_type) determined in step S324 for the pixel of interest P(x, y), and performs conversion into the gradation value Data2[x, y] of the second gradation number based on the comparison result. Specifically, the halftone processing section 13 sets Data2[x, y] to 255 (dot: on) when CorrectData[x, y]>EdThreshold(Data[x, y], angle_type) is established, and sets Data2[x, y] to 0 (dot: off) when CorrectData[x, y]≤EdThreshold(Data[x, y], angle_type) is established.

Next, in error calculation processing step S327, the halftone processing section 13 functions as the error calculation processing section 135 shown in FIG. 1, and the error calculation processing section 135 calculates the error Error[x, y] between the gradation value CorrectData[x, y] corrected in step S325 and the gradation value Data2[x, y] of the second gradation number converted in step S326 for the pixel of interest P(x, y). That is, Error[x, y]=CorrectData[x, y]−Data2[x, y].

Next, in error diffusion processing step S328, the halftone processing section 13 functions as the error diffusion processing section 136 shown in FIG. 1, and the error diffusion processing section 136 diffuses the error Error[x, y] calculated in step S327 to a plurality of pixels P around the pixel of interest P(x, y) to update the accumulated error DiffusedError. As an example, as shown in FIG. 6, the error diffusion processing section 136 updates each accumulated error DiffusedError for seven pixels P including a pixel P(x+1, y), a pixel P(x+2, y), a pixel P(x−2, y+1), a pixel P(x−1, y+1), a pixel P(x, y+1), a pixel P(x+1, y+1), and a pixel P(x+2, y+1) around the pixel of interest P(x, y) by the above-described Equations (1) to (7).

Next, the halftone processing section 13 performs the processing from step S322 again by setting x to x+1 (that is, x=x+1) in step S330 when x+n−1 in step S329. That is, the halftone processing section 13 performs the processing from step S322 on the pixel P(x+1, y) which is a right neighboring pixel of the pixel P(x, y) when x≠n−1 in step S329.

Further, the halftone processing section 13 performs the processing from step S322 again when x=n−1 in step S329, and when y≠m−1 in step S331 by setting x to 0 (that is, x=0) and by setting y to y+1 (that is, y=y+1) in step S332. That is, when x=n−1 in step S329, since the pixel P(x, y) is located at the right end, the halftone processing section 13 performs the processing from step S322 with respect to the pixel P(0, y+1) at a left end of the next raster.

Further, the halftone processing section 13 ends the halftone processing when y=m−1 in step S331. That is, when y=m−1 in step S331, since the pixel P(x, y) is located at a lower-right corner, the gradation number conversion processing for all the pixels P shown in FIG. 4 is already ended, and thus the halftone processing section 13 ends the halftone processing.

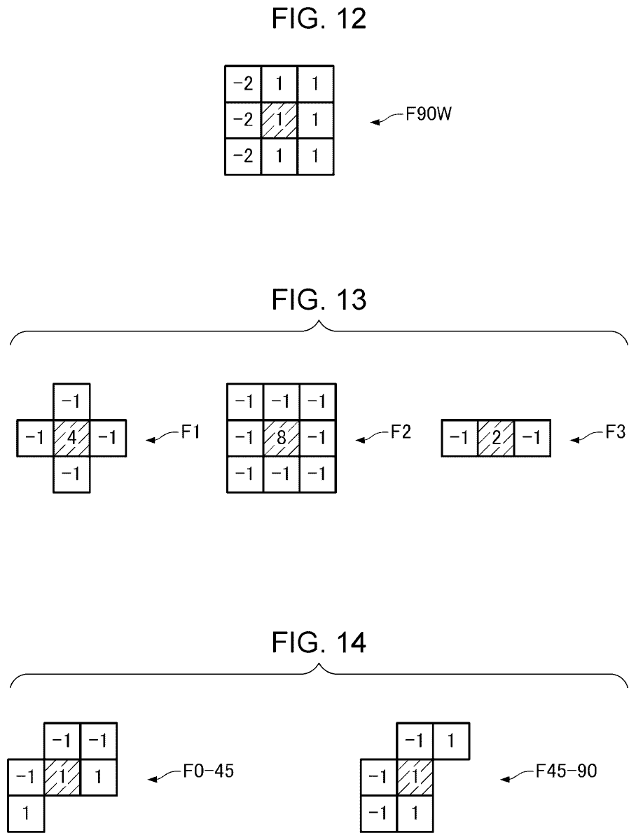

It is noted that the threshold shown in FIG. 11 is a threshold for reproducing a fine line having a width of one pixel with a white background (input gradation value of 0) at a dot density corresponding to the input gradation value, but the fine line having a width of one pixel with a white background is a condition that is most difficult to reproduce, and when this can be reproduced, at least a fine line having a width of two or more pixels does not disappear. Therefore, in the halftone processing of the present embodiment, the threshold EdThreshold(Data[x, y], angle_type) optimized with the white background and the fine line having a width of one pixel as the target is used. However, for example, when it is sufficient that a fine line having a width of two or more pixels can be reproduced, a threshold optimized for a fine line having a width of two pixels may be used. In addition, a threshold that varies depending on the width of the fine line may be set. For example, an edge detection filter F90W shown in FIG. 12 is a filter that can detect a left side edge of a line having an angle of 90° and a width of two or more pixels with an edge intensity twice that of a fine line having a width of one pixel. For example, by using the filter F90 shown in FIG. 10 and the filter F90W shown in FIG. 12 in combination, detection of the edge angle and setting of the threshold in which the width of the line is distinguished between one pixel or two pixels or more can be performed depending on whether.

In addition, when a difference between the threshold EdThreshold(Data[x, y]) used in the halftone processing of the comparative example and the threshold EdThreshold(Data[x, y], angle_type) used in the halftone processing of the present embodiment is set as an edge enhancement threshold operation amount EdThreshEnh(Data[x, y], angle_type), EdThreshold(Data[x, y], angle_type)=EdThreshold(Data[x, y])−EdThreshEnh(Data[x, y], angle_type). The edge enhancement threshold operation amount EdThreshEnh(Data[x, y], angle_type) may be changed to EdThreshEnh(Data[x, y], angle_type, edge_level) that is a function of an edge intensity edge_level obtained by Equation (12) described above, and the edge enhancement threshold operation amount EdThreshEnh(Data[x, y], angle_type, edge_level) may be reduced when the edge intensity edge_level is smaller than a predetermined value, or may be set to zero when the edge intensity edge_level is equal to or smaller than the predetermined value.

In addition, in the above description, an example of making the dot generation rate on the fine line equal to the input gradation value is described, but the edge enhancement in the original meaning by making the dot generation rate on the fine line larger than the input gradation value can also be performed.

For example, the halftone processing section 13 may execute the edge enhancement processing step before edge angle detection processing step S323 in FIG. 9, and may increase the input gradation value of the fine line itself. Specifically, in the edge enhancement processing step, the halftone processing section 13 adds an edge enhancement operation amount EdgeEnhance(angle_type, edge_level) to the gradation value Data[x, y] of the pixel of interest P(x, y) as in Equation (13) to calculate an edge enhanced gradation value EnhData[x, y].

$$EnhData [ x , y ] = Data [ x , y ] + EdgeEnhance ( angle\_type , edge\_level ) \qquad ( 13 )$$

The edge enhancement operation amount EdgeEnhance(angle_type, edge_level) is obtained by multiplying an enhancement control coefficient k for controlling the degree of edge enhancement by an edge intensity EdgeLevel of the pixel of interest P(x, y) as in Equation (14).

$$EdgeEnhance ( angle\_type , edge\_level ) = EdgeLevel \times k \qquad ( 14 )$$

The enhancement control coefficient k may be a fixed value, but enhancement can be strengthened in a gradation range in which a fine line is desired to be enhanced as a function of the gradation value Data[x, y], or enhancement cannot be performed when the edge intensity is equal to or less than a specific edge intensity as a function of the edge intensity EdgeLevel.

The edge intensity EdgeLevel of the pixel of interest P(x, y) is obtained by, for example, Equation (15) by using an edge detection filter F1 shown in FIG. 13.

$$EdgeLevel = Data [ x , y ] \times 4 - ( Data [ x , y - 1 ] + Data [ x - 1 , y ] + Data [ x + 1 , y ] ) + Data [ x , y + 1 ] \qquad ( 15 )$$

Alternatively, the halftone processing section 13 may calculate the edge intensity EdgeLevel of the pixel of interest P(x, y) by using edge detection filters F2 and F3 shown in FIG. 13, and the like. In each filter shown in FIG. 13, a position with a hatching corresponds to the position of the pixel of interest P(x, y).

As described above, the halftone processing section 13 can execute the edge enhancement processing step and directly control the dot generation rate on the fine line by increasing the input gradation value itself.

In addition, as another method for performing the edge enhancement in the original meaning, the halftone processing section 13 may further increase the edge enhancement threshold operation amount EdThreshEnh(Data[x, y], angle_type). In this method, it is necessary to separately investigate the correspondence between the edge enhancement threshold operation amount EdThreshEnh(Data[x, y], angle_type) and an increase amount of the actual dot generation rate, but the dot generation rate can be qualitatively increased.

In addition, in the edge angle detection processing step S323, the edge angle detection processing section 131 may add four types of filters for detecting edges at intermediate angles of these angles to the four types of filters F0, F45, F90, and F135 for detecting the edges at 0°, 45°, 90°, and 135° shown in FIG. 10, and detect eight types of edge angles angle_type. As an example, an edge detection filter F0-45 shown in FIG. 14 is a filter that detects an edge at an intermediate angle between 0° and 45°, and a filter F45-90 shown in FIG. 14 is a filter that detects an edge at an intermediate angle between 45° and 90°. In each filter shown in FIG. 14, a position with hatching corresponds to the position of the pixel of interest P(x, y).

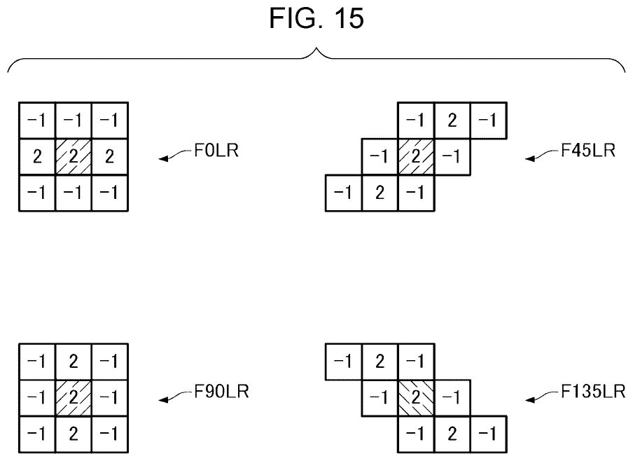

In the edge angle detection processing step S323, when edges of a low concentration fine lines are detected by using the four types of filters shown in FIG. 10, an edge intensity on an upstream in the x-direction is a positive value and an edge intensity on a downstream in the x-direction is a negative value, and thus only the upstream edge is detected. For the purpose of preventing the disappearance of the fine line, it is sufficient to enhance only one of the edges, and since a delay in dot generation occurs in the upstream edge in the error diffusion method, it is desirable to preferentially detect the upstream edge. However, of course, the downstream edge may be detected and enhanced. In that case, by using an edge detection filter as shown in FIG. 15 as an example, edges at both left and right ends can be detected with the same edge intensity. In FIG. 15, F0LR is an example of a filter that detects both edges at 0°, F45LR is an example of a filter that detects both edges at 45°, F90LR is an example of a filter that detects both edges at 90°, and F135LR is an example of a filter that detects both edges at 135°. In each filter, a position with a hatching corresponds to the position of the pixel of interest P(x, y).

### 1-4. Operations and Effects

As described above, in the image processing apparatus 1 of the first embodiment, the halftone processing section 13 detects the edge angle angle_type of each pixel P(x, y) as an angle of a fine line included in the first image data 23, determines the threshold EdThreshold(angle_type) for each pixel P(x, y) based on the edge angle angle_type, and converts the first image data 23 into the second image data 24 which is halftone image data by using the error diffusion method. In particular, the halftone processing section 13 can detect a plurality of angles such as an angle at which the fine line is likely to disappear and an angle at which the fine line is unlikely to disappear by a plurality of filters, and thus an appropriate threshold EdThreshold(angle_type) corresponding to the angle of the fine line for each pixel P(x, y) can be set. Therefore, according to the image processing apparatus 1 of the first embodiment, since the halftone processing section 13 sets the appropriate threshold EdThreshold(angle_type) corresponding to the edge angle angle_type for each pixel P(x, y), the halftone image data, in which a difference in reproducibility due to the angle of the fine line is reduced and the image quality is unlikely to be deteriorated, can be generated.

Further, according to the image processing apparatus 1 of the first embodiment, since the halftone processing section 13 sets the appropriate threshold EdThreshold(Data[x, y], angle_type) corresponding to the edge angle angle_type and the gradation value Data[x, y] for each pixel P(x, y), the halftone image data, in which the difference in reproducibility due to the angle of the fine line is reduced, the delay in dot generation and the occurrence of tailing are suppressed, and the image quality is less likely to be deteriorated, can be generated.

For example, the printer 2 can also reproduce a fine line having a width of one pixel or two pixels or a fine line with a low gradation value by forming dots on the medium M based on the halftone image data generated by the image processing apparatus 1.

### 2. Second Embodiment

Hereinafter, constituent elements of a second embodiment which are similar to those of the first embodiment will be given the same reference numerals, the description overlapping with the first embodiment will be omitted or simplified, and contents different from the first embodiment will be mainly described.

In the image processing apparatus 1 of the first embodiment, the halftone processing section 13 determines the threshold of the error diffusion method for the fine line based on the angle of the fine line. On the other hand, in the image processing apparatus 1 of the second embodiment, the halftone processing section 13 increases the gradation value of the fine line in correspondence with an angle of the fine line, and converts the first image data 23 in which the gradation value of the fine line is increased into the second image data 24 by using the error diffusion method.

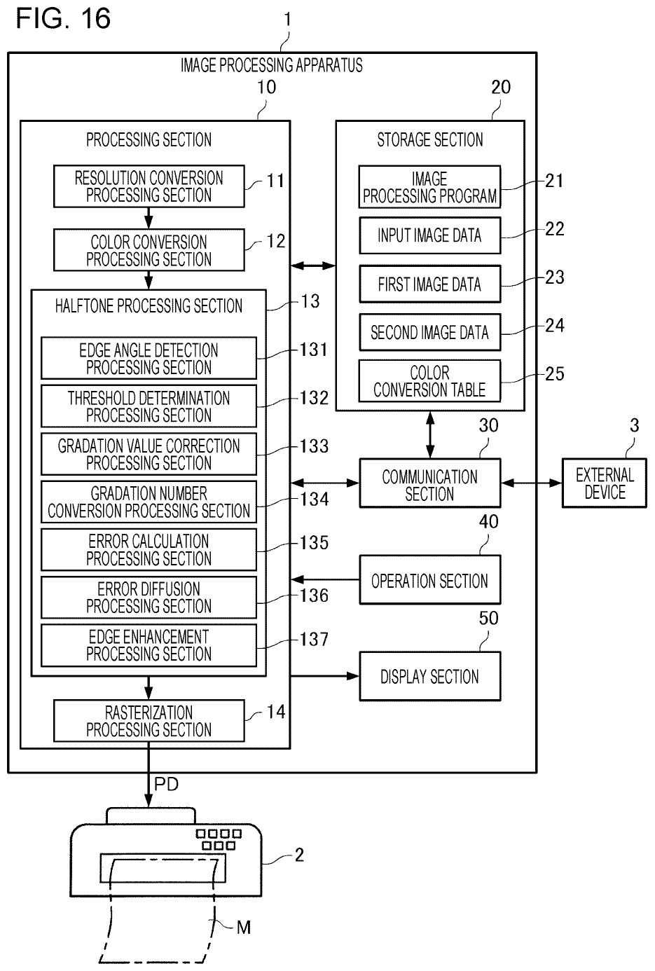

FIG. 16 is a block diagram illustrating a configuration of an image processing apparatus 1 according to the second embodiment. As shown in FIG. 16, in the image processing apparatus 1 of the second embodiment, the halftone processing section 13 includes the edge angle detection processing section 131, the threshold determination processing section 132, the gradation value correction processing section 133, the gradation number conversion processing section 134, the error calculation processing section 135, the error diffusion processing section 136, and an edge enhancement processing section 137, and each of these sections performs each processing to execute the halftone processing.

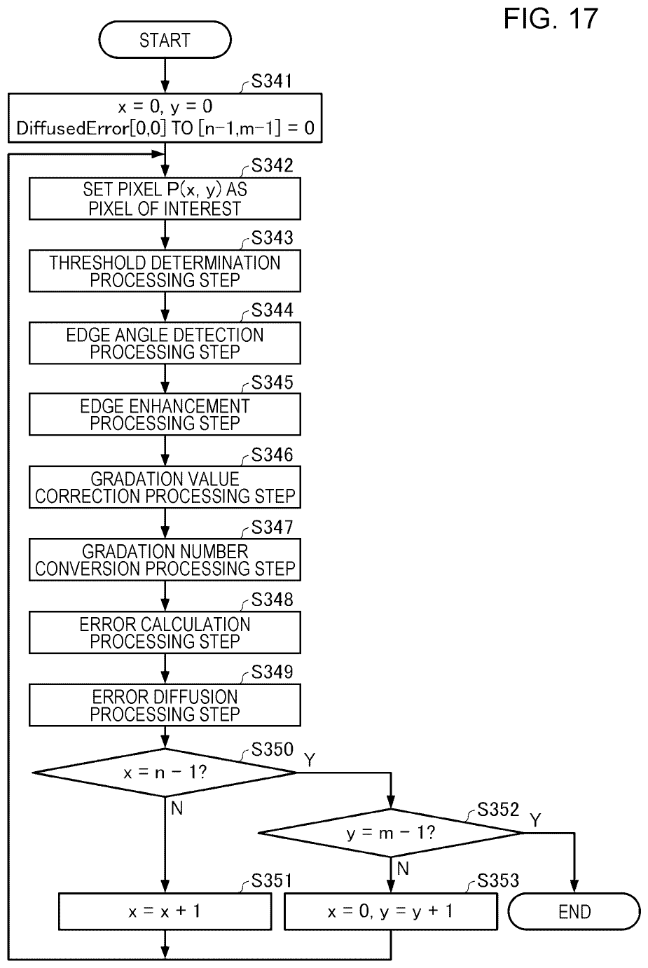

FIG. 17 is a flowchart illustrating a procedure of the halftone processing of the second embodiment. As shown in FIG. 17, the halftone processing section 13 initializes coordinates x and y to 0 in step S341. In step S342, the halftone processing section 13 sets a pixel P(x, y) included in the first image data 23 as a pixel of interest (processing target pixel), and performs processing from step S343 on the pixel P(x, y).

First, the halftone processing section 13 functions as the threshold determination processing section 132 shown in FIG. 16 in threshold determination processing step S343, and the threshold determination processing section 132 determines a threshold of the error diffusion method for each pixel based on a gradation value of each pixel included in the first image data 23. Specifically, in threshold determination processing step S343, the threshold determination processing section 132 determines the threshold EdThreshold(Data[x, y]) for the pixel of interest P(x, y) based on the gradation value Data[x, y] of the pixel of interest P(x, y). Since the processing in threshold determination processing step S343 is the same as the processing in threshold determination processing step S303 in FIG. 3, detailed description thereof will be omitted.

Next, the halftone processing section 13 functions as the edge angle detection processing section 131 shown in FIG. 16 in edge angle detection processing step S344, the edge angle detection processing section 131 detects the angle of the fine line included in the first image data 23. The fine line to be detected has, for example, a width of one pixel or two pixels. The edge angle detection processing section 131 may apply a plurality of filters for detecting each of a plurality of angles in a range of 0° to 180° to the fine line, and detect the angle of the fine line based on application results of the plurality of filters. Specifically, in edge angle detection processing step S344, the edge angle detection processing section 131 detects an edge angle angle_type of the pixel of interest P(x, y). Since the processing in edge angle detection processing step S344 is the same as the processing in edge angle detection processing step S323 in FIG. 9, detailed description thereof will be omitted.

Next, the halftone processing section 13 functions as the edge enhancement processing section 137 shown in FIG. 16 in edge enhancement processing step S345, and the edge enhancement processing section 137 increases a gradation value of the fine line in correspondence with the angle of the fine line detected in step S344. Specifically, in edge enhancement processing step S345, the edge enhancement processing section 137 adds an edge enhancement operation amount EdgeEnhance(angle_type, edge_level) to the gradation value Data[x, y] of the pixel of interest P(x, y) as in Equation (16) to calculate an edge enhanced gradation value EnhData[x, y].

$$EnhData [ x , y ] = Data [ x , y ] + EdgeEnhance ( angle\_type , edge\_level ) \qquad ( 16 )$$

An edge enhancement operation amount EdgeEnhance(angle_type, edge_level) is obtained by multiplying an enhancement control coefficient k[angle_type] for each angle for controlling the degree of edge enhancement on an edge intensity edge_level of the pixel of interest P(x, y) as in Equation (17). The edge intensity edge_level is obtained by, for example, Equations (8) to (12) described above.

$$EdgeEnhance ( angle\_type , edge\_level ) = EdgeLevel \times k [ angle\_type ] \qquad ( 17 )$$

The enhancement control coefficient k[angle_type] is increased as an angle that makes it difficult to reproduce the fine line becomes larger, and an input gradation value of the fine line itself is increased. For example, k[0] may be 1 (angle of 0°), k[1] may be 1.5 (angle of) 45°, k[2] may be 0.5 (angle of 90°), and k[3] may be 0 (angle of 135°). In addition, the edge enhancement operation amount EdgeEnhance(angle_type, edge_level) may be further changed to EdgeEnhance(angle_type, edge_level, Data[x, y]) which is a function of the gradation value Data[x, y] of the pixel of interest P(x, y), and the enhancement control coefficient k may be changed to an optimized value not only in correspondence with the edge angle angle_type but also in correspondence with the gradation value Data[x, y].

In edge angle detection processing step S344, a gradation value of the fine line for which the edge angle detection processing section 131 increases the gradation value in correspondence with the edge angle angle_type may be equal to or less than a predetermined value. For example, when the fine line having a gradation value of 32 or less is likely to disappear, the predetermined value may be set to 32.

In edge angle detection processing step S344, the edge angle detection processing section 131 may detect only an edge intensity edge_level_45 at an angle of 45° at which the fine line is most likely to disappear. In this case, in edge enhancement processing step S345, the edge enhancement processing section 137 may calculate a gradation value EnhData[x, y] in which the angle of 45° is edge enhanced by Equation (18). The edge enhancement operation amount EdgeEnhance(angle_type, edge_level) is calculated by Equation (14) described above.

$$EnhData [ x , y ] = Data [ x , y ] + EdgeEnhance ( angle\_type , edge\_level ) + edge\_level \_ 45 \qquad ( 18 )$$

In edge angle detection processing step S344, the edge angle detection processing section 131 may detect only the edge intensity edge_level_45 of the angle of 45° at which the fine line is most likely to disappear, and the edge intensity edge_level_0 of the angle of 0° at which the fine line is the next most likely to disappear. In this case, in edge enhancement processing step S345, the edge enhancement processing section 137 may calculate a gradation value EnhData[x, y] in which the angle of 45° is edge enhanced by Equation (19) and the angle of 0° is edge enhanced more weakly as compared with the angle of 45°.

$$EnhData [ x , y ] = Data [ x , y ] + EdgeEnhance ( angle\_type , edge\_level ) + edge\_level \_ 45 + edge\_level \_ 00 \times 0.5 \qquad ( 19 )$$

Next, in gradation value correction processing step S346, the halftone processing section 13 functions as the gradation value correction processing section 133 shown in FIG. 16, and the gradation value correction processing section 133 adds an accumulated error DiffusedError[x, y] to the gradation value Data[x, y] of the pixel of interest P(x, y) to correct the gradation value of the pixel of interest P(x, y). Since the processing in gradation value correction processing step S346 is the same as the processing in gradation value correction processing step S325 in FIG. 9, detailed description thereof will be omitted.

Next, in gradation number conversion processing step S347, the halftone processing section 13 functions as the gradation number conversion processing section 134 shown in FIG. 16, and the gradation number conversion processing section 134 compares the gradation value CorrectData[x, y] corrected in step S346 with the threshold EdThreshold(Data[x, y]) determined in step S343 for the pixel of interest P(x, y), and performs conversion into the gradation value Data2[x, y] having a second gradation number based on the comparison result. Since the processing in gradation number conversion processing step S347 is the same as the processing in gradation number conversion processing step S326 in FIG. 9, detailed description thereof will be omitted.

Next, in error calculation processing step S348, the halftone processing section 13 functions as the error calculation processing section 135 shown in FIG. 16, and the error calculation processing section 135 calculates an error Error[x, y] between the gradation value CorrectData[x, y] corrected in step S346 and the gradation value Data2[x, y] of the second gradation number converted in step S347 for the pixel of interest P(x, y). Since the processing in error calculation processing step S348 is the same as the processing in error calculation processing step S327 in FIG. 9, detailed description thereof will be omitted.

Next, in error diffusion processing step S349, the halftone processing section 13 functions as the error diffusion processing section 136 shown in FIG. 16, and the error diffusion processing section 136 diffuses the error Error[x, y] calculated in step S348 to a plurality of pixels P around the pixel of interest P(x, y) to update the accumulated error DiffusedError. Since the processing in error diffusion processing step S349 is the same as the processing in error diffusion processing step S328 in FIG. 9, detailed description thereof will be omitted.

Next, when x ¥ n−1 in step S350, the halftone processing section 13 performs the processing from step S342 again by setting x to x+1 (that is, x=x+1) in step S351. That is, the halftone processing section 13 performs the processing from step S342 on a pixel P(x+1, y) which is a right neighboring pixel of the pixel P(x, y) when x≠n−1 in step S350.

Further, the halftone processing section 13 performs the processing from step S342 again when x=n−1 in step S350 and y≠m−1 in step S352 by setting x to 0 (x=0) and by setting y to y+1 (that is, y=y+1) in step S353. That is, when x=n−1 in step S350, since the pixel P(x, y) is located at the right end, the halftone processing section 13 performs the processing from step S342 with respect to the pixel P(0, y+1) at a left end of a next raster.

Further, the halftone processing section 13 ends the halftone processing when y=m−1 in step S352. That is, when y=m−1 in step S352, since the pixel P(x, y) is located at a lower-right corner, the gradation number conversion processing for all the pixels P shown in FIG. 4 is already ended, and thus the halftone processing section 13 ends the halftone processing.

In threshold determination processing step S343, when the threshold of each pixel P(x, y) is set to a constant value such as a median value, a considerably extreme level of edge enhancement is required in edge enhancement processing step S345, and there is a concern that the edge enhancement affects neighboring pixels and side effects such as tailing occur. In contrast, in the present embodiment, in threshold determination processing step S343, the threshold EdThreshold(Data[x, y]) corresponding to the gradation value Data[x, y] of each pixel P(x, y) is set to accelerate generation of dots in the low concentration portion. Accordingly, the edge enhancement in edge enhancement processing step S345 is relatively small, and thus side effects such as tailing are less likely to occur.

Other configurations and functions of the image processing apparatus 1 of the second embodiment are the same as those of the image processing apparatus 1 of the first embodiment, and thus description thereof will be omitted.

As described above, in the image processing apparatus 1 of the second embodiment, the halftone processing section 13 detects the edge angle angle_type of each pixel P(x, y) as an angle of a fine line included in the first image data 23, increases the gradation value Data[x, y] of each pixel P(x, y) in correspondence with the edge angle angle_type, and then converts the first image data 23 into the second image data 24 which is halftone image data by using the error diffusion method. In particular, since the halftone processing section 13 can detect a plurality of angles such as an angle at which the fine line is likely to disappear and an angle at which the fine line is unlikely to disappear by a plurality of filters, the error diffusion method can be applied by appropriately increasing the gradation value Data[x, y] of each pixel P(x, y) in correspondence with the edge angle angle_type. Therefore, according to the image processing apparatus 1 of the second embodiment, the halftone processing section 13 applies the error diffusion method by appropriately increasing the gradation value Data[x, y] of each pixel P(x, y) in correspondence with the edge angle angle_type, and thus halftone image data, in which the difference in reproducibility due to the angle of the fine line is reduced and the image quality is unlikely to be deteriorated, can be generated.

Further, according to the image processing apparatus 1 of the second embodiment, the halftone processing section 13 sets an appropriate threshold EdThreshold(Data[x, y]) corresponding to the gradation value Data[x, y] for each pixel P(x, y), and thus halftone image data, in which the delay in dot generation and the occurrence of tailing are suppressed and the image quality is unlikely to be deteriorated, can be generated.

For example, the printer 2 can also reproduce a fine line having a width of one pixel or two pixels or a fine line with a low gradation value by forming dots on the medium M based on the halftone image data generated by the image processing apparatus 1.

### 3. Modification Example

The present disclosure is not limited to the present embodiments, and various modifications can be made within the scope of the spirit of the present disclosure.

For example, edge enhancement processing step S345 in the flowchart of FIG. 17 may be added after edge angle detection processing step S323 and before gradation value correction processing step S325 in the flowchart of FIG. 9 in the first embodiment. That is, the first embodiment and the second embodiment may be combined.

In addition, in each of the above embodiments, the first image data 23 is bitmap data in which the gradation value Data[x, y] of each pixel P(x, y) is designated, but may be image data described in various page description languages. The image data described in the page description languages includes various commands such as a command for drawing a line by designating coordinates of a start point and an end point, a gradation value, and a thickness, and thus the edge angle detection processing section 131 can detect an angle of a fine line by analyzing the command. For example, when coordinate values of the start point and the end point of the fine line are (x0, y0) and (x1, y1), respectively, the angle of the fine line is obtained by arctan((y1−y0)/(x1−x0)).

In addition, in each of the above embodiments, the main scanning direction of the error diffusion processing is fixed in the right direction, but the main scanning direction of the error diffusion processing may be changed in the right direction or the left direction alternately or randomly in a unit of raster. When the ratio of the right direction and the left direction is 1:1, the threshold may be set and the edge enhancement may be performed without distinguishing between a fine line of 45° and a fine line of 135°.

In addition, the image processing apparatus 1 of each of the above embodiments generates the second image data 24 corresponding to the image formed on the medium M by the printer 2, but may generate the second image data 24 corresponding to the image formed at a display, electronic paper, or the like.

In the image processing apparatus 1 according to each of the above embodiments, a part of the configuration realized by hardware may be replaced with software (a computer program), or at least a part of the configuration realized by software may be replaced with hardware. The software (computer program) may be stored in a computer-readable information storage medium. The information storage medium may be a storage device such as a flexible disk, a CD-ROM, various RAMs and ROMs, and a hard disk.

The present disclosure includes substantially the same configurations (for example, configurations having the same functions, methods, and results, or configurations having the same objects and effects) as the configurations described in the present embodiment. In addition, the present disclosure includes configurations in which non-essential parts of the configuration described in the present embodiment are replaced. In addition, the present disclosure includes configurations that achieve the same operations and effects or configurations that can achieve the same objects as those of the configurations described in the present embodiments. In addition, the present disclosure includes configurations in which a known technology is added to the configurations described in the present embodiments.

The embodiments and the modification example described above are merely examples, and the present disclosure is not limited thereto. For example, each embodiment and each modification example can be combined as appropriate.

The following contents are derived from the above-described embodiments and modification examples.

According to an aspect, there is provided an image processing apparatus configured to convert first image data having a first gradation number into second image data having a second gradation number smaller than the first gradation number by using an error diffusion method, the apparatus including:
an edge angle detection processing section configured to detect an angle of a fine line included in the first image data; and
a threshold determination processing section configured to determine a threshold of the error diffusion method for each pixel included in the first image data based on the angle of the fine line.

In this image processing apparatus, the angle of the fine line included in the first image data is detected, the threshold for each pixel included in the first image data is determined based on the angle of the fine line, and the error diffusion method is used to convert the first image data into the second image data which is the halftone image data. Therefore, according to the image processing apparatus, a difference in reproducibility due to the angle of the fine line can be reduced by setting an appropriate threshold corresponding to the angle of the fine line for each pixel, and the halftone image data, in which the image quality is unlikely to be deteriorated, can be generated.

In the image processing apparatus according to the aspect, the threshold determination processing section may determine the threshold for each pixel based on the angle of the fine line and a gradation value of each pixel.

According to the image processing apparatus, by setting an appropriate threshold corresponding to the angle of the fine line and the gradation value of each pixel with respect to each pixel, the difference in reproducibility due to the angle of the fine line can be reduced, the delay in dot generation and the occurrence of tailing can be suppressed, and halftone image data in which the image quality is unlikely to deteriorate can be generated.

In the image processing apparatus according to the aspect, the edge angle detection processing section may apply a plurality of filters configured to detect each of a plurality of angles in a range of 0° to 180° to the fine line, and may detect the angle of the fine line based on application results of the plurality of filters.

According to the image processing apparatus, the plurality of angles such as an angle at which the fine line is likely to disappear and an angle at which the fine line is unlikely to disappear can be detected by the plurality of filters, and thus an appropriate threshold corresponding to the angle of the fine line can be set for each pixel.

In the image processing apparatus according to the aspect, the fine line may have a width of one pixel or two pixels.

According to the image processing apparatus, the halftone image data for reproducing the fine line having a width of one pixel or two pixels can be generated.

In the image processing apparatus according to the aspect, a gradation value of the fine line may be equal to or less than a predetermined value.

According to the image processing apparatus, the halftone image data for reproducing the fine line with a low gradation value can be generated.

According to another aspect, there is provided an image processing apparatus configured to convert first image data having a first gradation number into second image data having a second gradation number smaller than the first gradation number by using an error diffusion method, the apparatus including:
an edge angle detection processing section configured to detect an angle of a fine line included in the first image data; and
an edge enhancement processing section configured to increase a gradation value of the fine line in correspondence with the angle of the fine line,
in which the image processing apparatus converts the first image data in which the gradation value of the fine line is increased into the second image data by using the error diffusion method.

In this image processing apparatus, the angle of the fine line included in the first image data is detected, the gradation value of the fine line is increased in correspondence with the angle of the fine line, and then the first image data is converted into the second image data which is the halftone image data by using the error diffusion method. Therefore, according to the image processing apparatus, by appropriately increasing the gradation value of the fine line in correspondence with the angle of the fine line and applying the error diffusion method, a difference in reproducibility due to the angle of the fine line can be reduced and the halftone image data, in which the image quality is unlikely to be deteriorated, can be generated.

The image processing apparatus according to the aspect may further include a threshold determination processing section configured to determine a threshold of the error diffusion method for each pixel based on a gradation value of each pixel included in the first image data.

According to the image processing apparatus, by setting an appropriate threshold corresponding to the gradation value for each pixel, halftone image data, in which the delay in dot generation and the occurrence of tailing are suppressed and the image quality is unlikely to deteriorate, can be generated.

In the image processing apparatus according to the aspect, the edge angle detection processing section may apply a plurality of filters configured to detect each of a plurality of angles in a range of 0° to 180° to the fine line and may detect the angle of the fine line based on application results of the plurality of filters.

According to the image processing apparatus, the plurality of angles such as an angle at which the fine line is likely to disappear and an angle at which the fine line is unlikely to disappear can be detected by the plurality of filters, and thus the error diffusion method can be applied by appropriately increasing the gradation value of the fine line in correspondence with the angle of the fine line.

In the image processing apparatus according to the aspect, the fine line may have a width of one pixel or two pixels.

According to the image processing apparatus, the halftone image data for reproducing the fine line having a width of one pixel or two pixels can be generated.

In the image processing apparatus according to the aspect, the gradation value of the fine line may be equal to or less than a predetermined value.

According to the image processing apparatus, the halftone image data for reproducing the fine line with a low gradation value can be generated.

According to still another aspect, there is provided an image processing method of converting first image data having a first gradation number into second image data having a second gradation number smaller than the first gradation number by using an error diffusion method, the method including:
detecting an angle of a fine line included in the first image data; and
determining a threshold of the error diffusion method for the fine line based on the angle of the fine line.

In this image processing method, the angle of the fine line included in the first image data is detected, the threshold for each pixel included in the first image data is determined based on the angle of the fine line, and the error diffusion method is used to convert the first image data into the second image data which is the halftone image data. Therefore, according to the image processing method, a difference in reproducibility due to the angle of the fine line can be reduced by setting an appropriate threshold corresponding to the angle of the fine line for each pixel, and the halftone image data, in which the image quality is unlikely to be deteriorated, can be generated.

According to still another aspect of the present disclosure, there is provided an image processing method of converting first image data having a first gradation number into second image data having a second gradation number smaller than the first gradation number by using an error diffusion method, the method including:
detecting an angle of a fine line included in the first image data;
increasing a gradation value of the fine line in correspondence with the angle of the fine line; and
converting the first image data in which the gradation value of the fine line is increased into the second image data by using the error diffusion method.

In this image processing method, the angle of the fine line included in the first image data is detected, the gradation value of the fine line is increased in correspondence with the angle of the fine line, and then the first image data is converted into the second image data which is the halftone image data by using the error diffusion method. Therefore, according to the image processing method, by appropriately increasing the gradation value of the fine line in correspondence with the angle of the fine line and applying the error diffusion method, a difference in reproducibility due to the angle of the fine line can be reduced and the halftone image data, in which the image quality is unlikely to be deteriorated, can be generated.

What is claimed is:

1. An image processing apparatus configured to convert first image data having a first gradation number into second image data having a second gradation number smaller than the first gradation number by using an error diffusion method, the apparatus comprising:
an edge angle detection processing section configured to detect an angle of a fine line included in the first image data; and
a threshold determination processing section configured to determine a threshold of the error diffusion method for each pixel included in the first image data based on the angle of the fine line.

2. The image processing apparatus according to claim 1, wherein
the threshold determination processing section determines the threshold for each pixel based on the angle of the fine line and a gradation value of each pixel.

3. The image processing apparatus according to claim 1, wherein
the edge angle detection processing section applies a plurality of filters configured to detect each of a plurality of angles in a range of 0° to 180° to the fine line, and detect the angle of the fine line based on application results of the plurality of filters.

4. The image processing apparatus according to claim 1, wherein
the fine line has a width of one pixel or two pixels.

5. The image processing apparatus according to claim 1, wherein
a gradation value of the fine line is equal to or less than a predetermined value.

6. An image processing apparatus configured to convert first image data having a first gradation number into second image data having a second gradation number smaller than the first gradation number by using an error diffusion method, the apparatus comprising:
an edge angle detection processing section configured to detect an angle of a fine line included in the first image data; and
an edge enhancement processing section configured to increase a gradation value of the fine line in correspondence with the angle of the fine line, wherein
the image processing apparatus converts the first image data in which the gradation value of the fine line is increased into the second image data by using the error diffusion method.

7. The image processing apparatus according to claim 6, further comprising:
a threshold determination processing section configured to determine a threshold of the error diffusion method for each pixel based on a gradation value of each pixel included in the first image data.

8. The image processing apparatus according to claim 6, wherein
the edge angle detection processing section applies a plurality of filters configured to detect each of a plurality of angles in a range of 0° to 180° to the fine line and detect the angle of the fine line based on application results of the plurality of filters.

9. The image processing apparatus according to claim 6, wherein
the fine line has a width of one pixel or two pixels.

10. The image processing apparatus according to claim 6, wherein
the gradation value of the fine line is equal to or less than a predetermined value.

11. An image processing method of converting first image data having a first gradation number into second image data having a second gradation number smaller than the first gradation number by using an error diffusion method, the method comprising:
detecting an angle of a fine line included in the first image data; and
determining a threshold of the error diffusion method for the fine line based on the angle of the fine line.

12. An image processing method of converting first image data having a first gradation number into second image data having a second gradation number smaller than the first gradation number by using an error diffusion method, the method comprising:
detecting an angle of a fine line included in the first image data;
increasing a gradation value of the fine line in correspondence with the angle of the fine line; and
converting the first image data in which the gradation value of the fine line is increased into the second image data by using the error diffusion method.
